(19) United States
(12) Patent Application Publication
(10) Pub. No.: US 2022/0319286 A1
(43) Pub. Date: Oct. 6, 2022

(54) ANNOUNCER BALL

(71) Applicant: St. Clair Pinckney, South Fulton, GA (US)

(72) Inventor: St. Clair Pinckney, South Fulton, GA (US)

(21) Appl. No.: 17/712,043

(22) Filed: Apr. 1, 2022

Related U.S. Application Data
(60) Provisional application No. 63/169,273, filed on Apr. 1, 2021.

(51) Int. Cl. G08B 5/38

(52) U.S. Cl. CPC G08B 5/38; A63B 43/06

(57) ABSTRACT

Implementations of an announcer ball comprise a structure configured to be tossed or otherwise deployed and to provide a lighted visual indicator, such as a blue light indicator, to indicate the entry and presence of police or other personnel in a location. In some implementations, a method of using the announcer ball comprises tossing or otherwise deploying the announcer ball into a dwelling or other suitable location and the announcer ball emitting a lighted visual indicator, such as a blue light indicator, in the location to indicate the entry and presence of police or other personnel.

### CROSS REFERENCE TO RELATED APPLICATION

This application claims the benefit of U.S. Patent Application Ser. No. 63/169,273, which was filed on Apr. 1, 2021, and is incorporated herein by reference in its entirety.

### TECHNICAL FIELD

This disclosure relates to implementations of an announcer ball configured to be deployed into a location to visually indicate the entry and presence of police or other personnel to occupants of the location.

### BACKGROUND

Americans have the right against unreasonable searches and seizures. Thus, generally speaking, police cannot search a person or his property without a warrant (i.e., a court order to search a person's property or person). More specifically, police typically cannot enter a person's home without a warrant. Typically, when executing a search warrant of a person's home, the police must knock and announce their presence.

No-knock warrants are search warrants that police can obtain from a judge granting the police permission to enter a person's home without knocking or announcing their presence. These are typically issued when there is a risk of the destruction of evidence once police announce their presence or that police safety will be compromised.

However, no-knock warrants are very dangerous because if a person does not know police are entering his/her home, the person has the right to protect himself/herself using deadly force against intruders (i.e., someone entering his/her home without permission). Thus, when police enter a person's home unannounced pursuant to a no-knock warrant, the occupant can use deadly force (e.g., a gun) to protect himself/herself until they become aware that it is the police entering the person's home.

Therefore, no-knock warrants have led to injury including death of home occupants and police officers because of violence that has erupted during the execution of a no-knock warrant where home occupants thought police were intruders because the police did not announce themself. Similar risks of unintended violence and injury exists for other forced or unannounced entry by law enforcement, such as to serve other applicable warrants (e.g., arrest, fugitive, etc.), particularly during non-daylight times. Furthermore, such risks of unintended violence and injury may exist for forced or unannounced entry by other entities, such as emergency medical personnel, utility personnel (e.g., responding to a gas leak or other applicable utility emergency), or other applicable service providers (e.g., for maintenance services, deliveries, etc.).

### BRIEF DESCRIPTION OF THE DRAWINGS

FIG. 1 illustrates an implementation of an example announcer ball according to the present disclosure.

FIGS. 2A-2K illustrates another implementation of an example announcer ball according to the present disclosure.

FIG. 3 illustrates another implementation of an example announcer ball according to the present disclosure.

### DETAILED DESCRIPTION

Implementations of an announcer ball are provided. In some implementations, the announcer ball comprises a structure (e.g., three-dimensional) configured to be tossed or otherwise deployed and to provide a lighted visual indicator, such as a blue light indicator, to indicate the entry and presence of police or other personnel in a location.

In some implementations, the structure is ball-like. In some implementations, the structure of the announcer ball may be a multi-faced, three-dimensional structure or similarly configured. In some implementations, the announcer ball may be a handheld structure. In some implementations, the announce ball may be a sized to be tossed, thrown, or rolled from a user's hand.

In some implementations, the announcer ball is configured to and used to help reduce injury to home occupants and police when the police use a no-knock warrant to enter a dwelling or otherwise enter a dwelling.

In some implementations, the announcer ball is configured to and used to help quickly identify police once they have made entry into a dwelling (e.g., a house) pursuant to a no-knock warrant or otherwise.

In some implementations, the announcer ball is configured to emit blue light as a visual indicator to announce the presence of police before or once they have made entry into a dwelling pursuant to a no-knock warrant or otherwise. In this way, in some implementations, use of the announcer ball is advantageous over only a verbal or other sound indicator since a sound indicator may not be heard over the commotion of a no-knock warrant entry or other noise in the environment.

In some implementations, the announcer ball is configured to emit blue light when the announcer ball is tossed, thrown, or otherwise deployed into a dwelling during entry by police pursuant to a no-knock warrant or otherwise.

In some implementations, the announcer ball may be configured to emit any other suitable colored light when the announcer ball is used.

In some implementations, the announcer ball may be used for other forced and/or unannounced entry into a dwelling by law enforcement, such as to serve other applicable warrants (e.g., arrest, fugitive, etc.), particularly during non-daylight times.

In some implementations, the announcer ball may be used for forced and/or unannounced entry by other persons, such as emergency medical personnel, utility personnel (e.g., responding to a gas leak or other applicable utility emergency), or other service providers (e.g., for maintenance services, deliveries, etc.).

In some implementations, a method of using the announcer ball comprises tossing, rolling, throwing, or otherwise deploying the announcer ball into a dwelling or other suitable location and the announcer ball emitting a lighted visual indicator, such as a blue light indicator, in the location to indicate the entry and presence of police or other personnel.

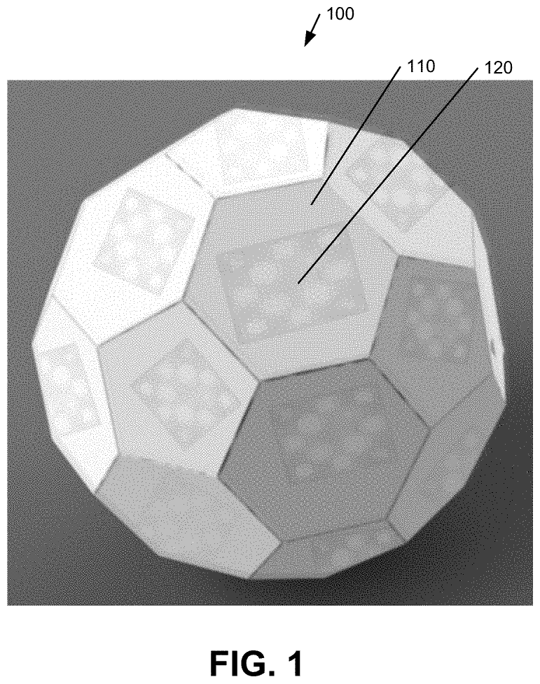

FIG. 1 illustrates an implementation of an example announcer ball 100 according to the present disclosure. As shown in FIG. 1, in some implementations, the announcer ball 100 comprises material forming a ball-like structure having an enclosure wherein the announcer ball is configured to provide a lighted visual indicator, such as a blue light indicator. In some implementations, the structure of the announcer ball 100 may be a multi-faced 110, three-dimensional structure or similarly configured.

In some implementations, the announcer ball 100 may comprise any other suitable components to provide the lighted visual indicator, such as a power source, a power switch, a controller, etc., such as described below.

As shown in FIG. 1, in some implementations, each face 110 of the announcer ball 100 may comprise a light source 120.

As shown in FIG. 1, in some implementations, each face 110 is a flat polygon, such as a pentagon or hexagon, as further described below. In some implementations, each face 110 may be any other suitable shape.

In some implementations, each light source 120 may be any suitable light source. For example, in some implementations, the light source 120 may be a light emitting diode (LED).

In some implementations, the light source 120 is any suitable blue color such that it is recognized to indicate police or other suitable law enforcement. For example, in some implementations, the light source 120 is the same or similar color to blue lights on a police car.

In some implementations, the light source 120 may be any other suitable color.

In some implementations, a light source 120 is embedded or otherwise attached to one or more faces 110 of the announcer ball 100. In some implementations, a light source 120 is attached to one or more faces 110 such that light is emitted from the announcer ball 100 in multiple directions.

For example, as shown in FIG. 1, in some implementations, a light source 120 may be embedded or otherwise attached to each face 110. In some implementations, a light source 120 may be attached to some of the faces 110 and not to others in any suitable configuration.

In some implementations, more than one light source 120 may be attached to any suitable face 110 of the announcer ball 100.

In some implementations, the light source 120 may be otherwise configured to emit a blue colored light that it is recognized to indicate police or other suitable law enforcement. For example, in some implementations, the light source 120 may be otherwise configured to emit the same or similar colored light that the blue lights emit from a police car.

In some implementations, the light source 120 may be otherwise configured to emit any other suitable colored light.

In some implementations, the light source 120 is configured to emit a very bright or high intensity light. For example, in some implementations, the light source 120 is configured to emit a light that is bright enough to be seen in multiple rooms of a dwelling or other suitable location.

In some implementations, the light sources 120 are configured to emit light from the faces 110 such that light is emitted from the announcer ball 100 in multiple directions.

In some implementations, the light sources 120 may be configured to be turned on and/or off manually, such as by a user operating a switch or other suitable control. In some implementations, the light sources 120 may be configured to be turned on and/or off automatically, such as when the announcer ball 100 is tossed, rolled, thrown, or otherwise deployed.

In some implementations, the light sources 120 may be configured to be turned on and/or off in any other suitable way.

In some implementations, the light sources 120 may be configured to emit light in any suitable way. For example, in some implementations, the light sources 120 may be configured to emit a flashing light. In some implementations, the light sources 120 may be configured to emit a constant or steady light.

In some implementations, the light sources 120 are configured to emit light such that the announcer ball 100 provides a visual indicator of the presence of police at a dwelling or other suitable location.

As introduced above, in some implementations, the announcer ball 100 may comprise any other suitable components to provide a lighted (e.g., blue light) visual indicator of police presence, such as a power source, a power switch, a controller, etc. (not shown).

In some implementations, the power source may be any suitable power source, such as a battery which may be rechargeable and/or replaceable.

In some implementations, the power switch may be any suitable power switch that can turn on and/or off the light sources 120 or other suitable components of the announcer ball 100.

In some implementations, the controller may be any suitable controller, processor, and/or other components that can control the light sources 120 or other suitable components of the announcer ball 100.

As shown in FIG. 1, in some implementations, the multi-face, three-dimensional structure of the announcer ball 100 is in the form of a truncated icosahedron. For example, in some implementations, the announcer ball 100 may comprise a total of thirty-two (32) faces 110, wherein twelve (12) of the faces are regular pentagons and twenty (20) of the faces are regular hexagons. This geometry of the announcer ball may be similar to the shape of a soccer ball.

In some implementations, the multi-face, three-dimensional structure of the announcer ball 100 may be in any other suitable the form. In some implementations, the faces 110 of the announcer ball 100 may be in any other suitable configuration.

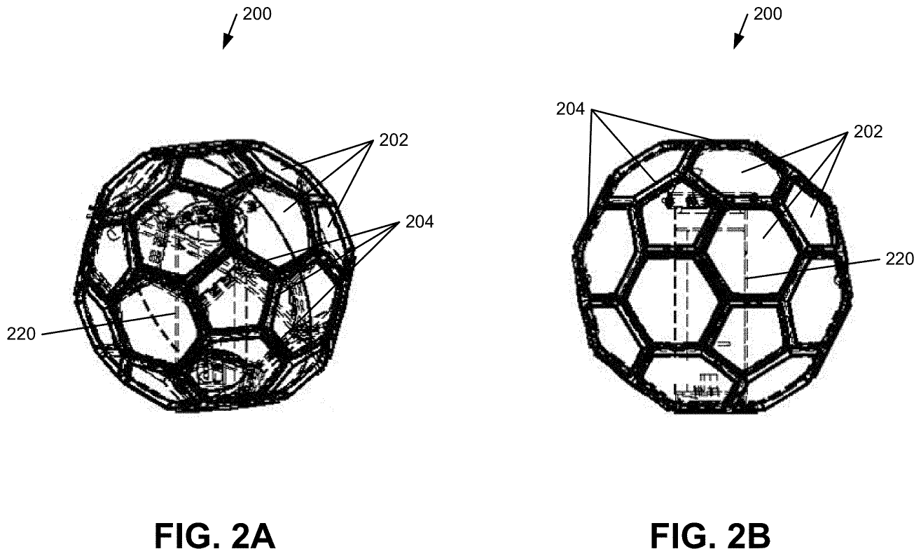

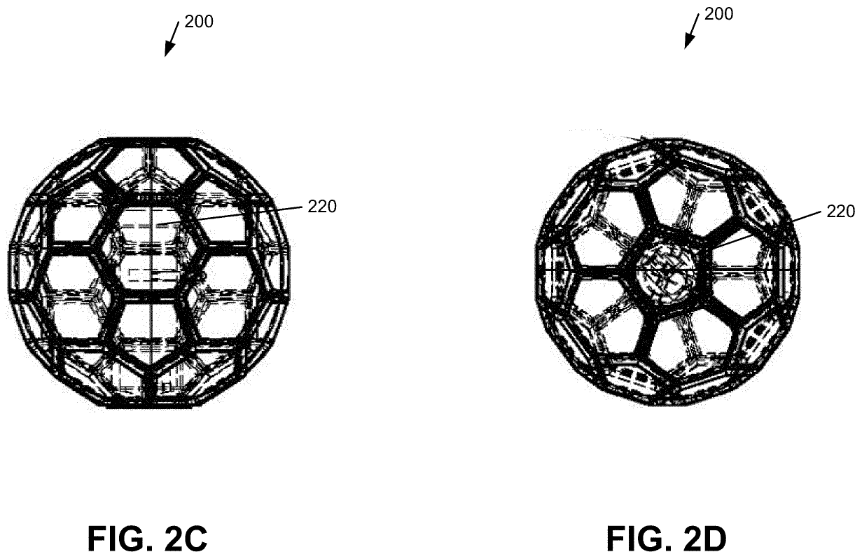

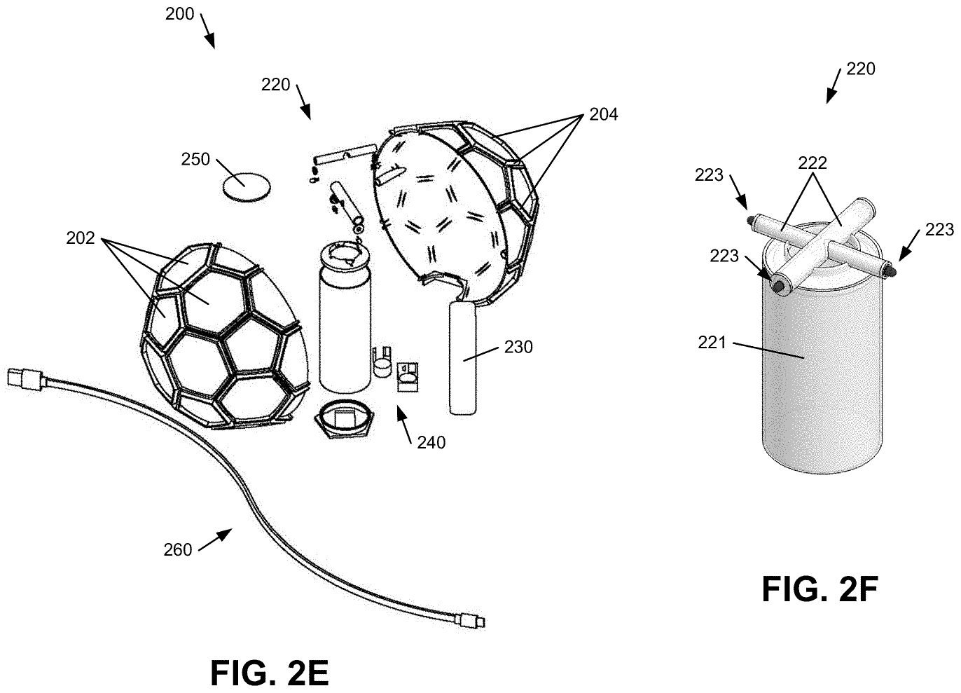

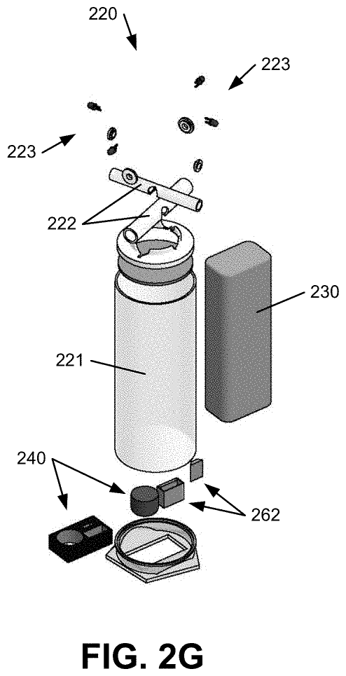

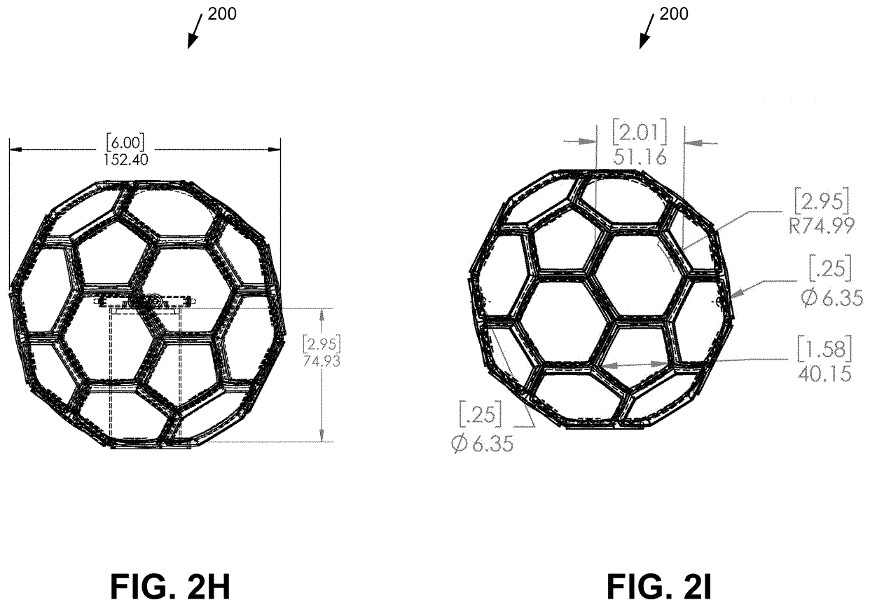

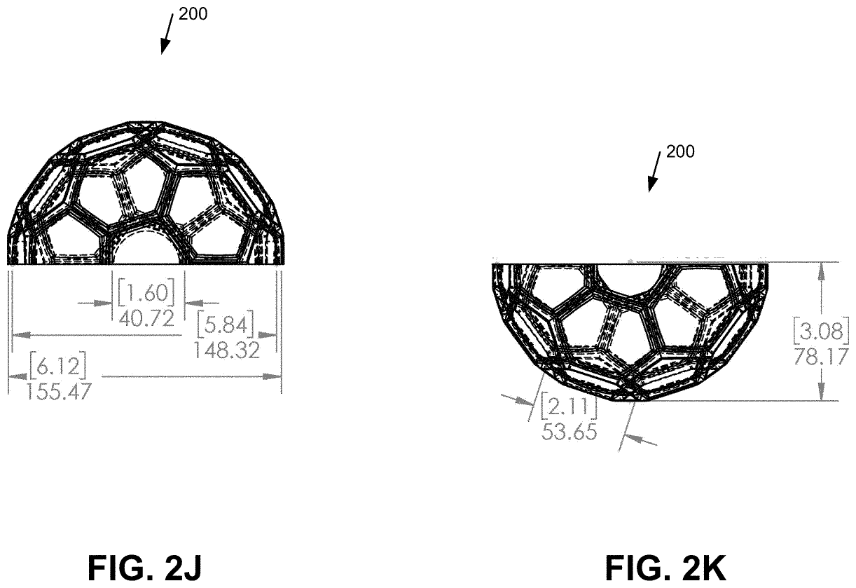

FIGS. 2A-2K illustrates another implementation of an example announcer ball 200 according to the present disclosure. As shown in FIGS. 2A-2D, in some implementations, the announcer ball 200 comprises material forming a ball-like structure 202 having an enclosure. In some implementations, the ball-like structure 202 of the announcer ball 200 is configured to provide a lighted visual indicator, such as a blue light indicator.

As shown in FIGS. 2A-2D, in some implementations, the ball-like structure 202 of the announcer ball 200 may be a multi-faced, three-dimensional structure or similarly configured. For example, in some implementations, the announcer ball 200 also comprises a multi-face frame 204 that is shaped the same or similar to the multi-face, three-dimensional structure (e.g., to the outline of the faces 110) of the announcer ball 100, as further described below.

In some implementations, as shown in FIGS. 2B and 2F, the announcer ball 200 comprises a lighted visual indicator 220, which as described further below comprises a power source 230, a power switch 240, a controller 250.

As shown in FIGS. 2E and 2G, in some implementations, the announcer ball 200 may further comprise other suitable components, such as a charging cable 260 and one or more corresponding charging ports 262.

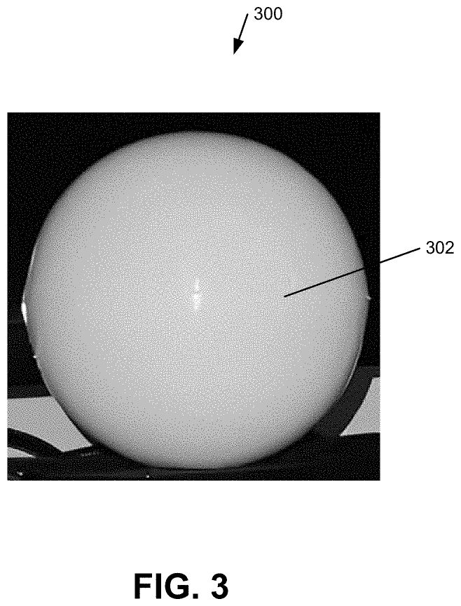

As shown in FIGS. 2B and 2E (similar to as shown in FIG. 3), in some implementations, the inner surface of the ball-like structure is generally ball-shaped, such as round, spherical, etc. That is, in some implementations, the inner surface is smooth.

As shown in FIGS. 2B and 2E, in some implementations, the ball-like structure 202 is configured (e.g., sized and/or shaped) to house or enclose and interface with the lighted visual indicator 220 positioned in the enclosure.

As shown in FIGS. 2A-2E, in some implementations, the multi-face frame 204 is a frame-like structure that positions on and/or around the exterior of the ball-like structure 202. In some implementations, the frame 204 can be integral to the remaining outer border of the announcer ball 200 (e.g., made from a mold).

As introduce above, in some implementations, the multi-face frame 204 is shaped the same or similar to the multi-face, three-dimensional structure of the announcer ball 100 as described above for FIG. 1. For example, in some implementations, the multi-face frame 204 is shaped the same or similar to the outline of the faces 110 of multi-face, three-dimensional structure of the announcer ball 100 of FIG. 1. That is, in some implementations, the multi-face frame 204 is shaped the same or similar to the outline of a truncated icosahedron or other suitable configuration, such as described above for the announcer ball 100 of FIG. 1.

In some implementations, the multi-face frame 204 is configured (e.g., sized and/or shaped) to position on, over, and/or around the ball-like structure 202 of the announcer ball 200.

In some implementations, the multi-face frame 204 is also configured such that the multi-face frame 204 extends partly away from the ball-like structure 202 in a raised, exoskeletal-like configuration. In this way, in some implementations, the announcer ball 200 is configured to rest at least partly on a portion of the multi-face frame 204 when the announcer ball 200 is thrown or otherwise deployed to land on a surface (such as a floor).

Furthermore, in this way, in some implementations, the multi-face frame 204 at least partly prevents the announcer ball 200 from moving (e.g., rolling along a surface) after the announcer ball 200 is deployed.

In some implementations, the lighted visual indicator 220 may have any suitable structure, configuration, and components such that the lighted visual indicator 220 can emit a lighted (e.g., blue lighted) visual indication when the announcer ball 200 is used. For example, in some implementations, the lighted visual indicator 220 may comprise any suitable device that can provide such function of the announcer ball 200.

As shown in FIG. 2F, in some implementations, the lighted visual indicator 220 may comprise a base portion 221 that supports one or more light supporting portions 222, which support one or more light sources 223.

As shown in FIG. 2F, in some implementations, the base portion 221 may comprise a generally elongated cylindrical shape (e.g., extending generally vertically when the announcer ball 200 is in an upright position). In some implementations, the base portion 221 may comprise any other suitable shape.

As shown in FIG. 2F, in some implementations, the light supporting portions 222 may also comprise a generally elongated cylindrical shape (e.g., extending generally horizontally when the announcer ball 200 is in an upright position). In some implementations, the light supporting portions 222 may comprise any other suitable shape.

As shown in FIG. 2F, in some implementations, the light supporting portions 222 position on top of the base portion 221. In some implementations, the light supporting portions 222 may position on any other suitable location of the base portion 221.

In some implementations, the light supporting portions 222 may be attached to the base portion 221 in a fixed (e.g., non-moving) configuration. In some implementations, the light supporting portions 222 may alternately be attached to the base portion 221 in a moveable configuration, such as rotational or otherwise.

In some implementations, the light supporting portions 222 may be attached to the base portion 221 in any other suitable configuration.

In some implementations, the light sources 223 may be any suitable light sources. For example, in some implementations, the light sources 223 are light-emitting diodes (LEDs).

In some implementations, the light sources 223 may be configured to emit any suitable color of light. For example, in some implementations, the light sources 223 are configured to emit blue colored light to provide a visual indicator of police entry and presence when the announcer ball 200 is used.

Additionally, in some implementations, the light sources 223 may comprise one or more of the same or similar features to the light sources 120 of the announcer ball 100 of FIG. 1.

As shown in FIG. 2F, in some implementations, the light sources 223 are attached to the ends of the light supporting portions 222. In some implementations, the light sources 223 may be attached to any other suitable location of the light supporting portions 222.

In some implementations, the light sources 223 may be detachable from the light supporting portions 222, for example to allow replacement of the light sources 223.

In some implementations, the power source 230 may be the same or similar to the power source of the announcer ball 100 of FIG. 1. For example, in some implementations, the power source may be any suitable power source, such as a battery which may be rechargeable and/or replaceable.

In some implementations, the power source 230 may position in any suitable location of the announcer ball 200. For example, in some implementations, the power source 230 may position in or adjacent to the lighted visual indicator 220, such as within the base portion 221.

In some implementations, the power switch 240 may be the same or similar to the power switch of the announcer ball 100 of FIG. 1. For example, in some implementations, the power switch may be any suitable power switch that can turn on and/or off the light sources 223 or other suitable components of the announcer ball 200. In some implementations, the power switch 240 may be a pushbutton switch, a rocker switch, or any other suitable switch.

In some implementations, the power switch 240 may position in any suitable location of the announcer ball 200. For example, in some implementations, the power switch 240 may position at or adjacent to the bottom of the announcer ball 200 when the announcer ball 200 positioned upright. In some implementations, the power switch 240 may position at or adjacent to the bottom of the announcer ball 200 by positioning on and/or extending from the lighted visual indicator 220.

In some implementations, the controller 250 may be the same or similar to the controller of the announcer ball 100 of FIG. 1. For example, in some implementations, the controller may be any suitable controller, processor, and/or other components that can control the light sources 223 or other suitable components of the announcer ball 200.

In some implementations, the controller 250 may comprise a computer system, such as a system-on-chip (SOC) computer system, a single-board computer system (SBC), or any other suitable computer system.

In some implementations, the controller 250 may position in any suitable location of the announcer ball 200. For example, in some implementations, the controller 250 may position in or adjacent to the lighted visual indicator 220, such as within the base portion 221.

In some implementations, the charging cable 260 may be any suitable charging cable. For example, in some implementations, the charging cable may be a universal serial bus (USB) charging cable having one or more types of USB connectors.

In some implementations, the charging cable 260 may be attachable and detachable from the announcer ball 200. In some implementations, the charging cable 260 may comprise any other suitable features.

In some implementations, the charging cable 260 is configured to connect the announcer ball 200 to an external power source, such as by a wall receptacle, to charge the power source 230 of the announcer ball 200.

In some implementations, the one or more charging ports 262 may be any suitable charging ports. For example, in some implementations, the charging ports may be USB charging ports that allow the connection of one or more types of USB connectors.

In some implementations, the charging ports 262 are configured to allow the connection of the charging cable 260 to the announcer ball 200.

In some implementations, the announcer ball 200 may be any suitable size. In some implementations, the announcer ball 200 may be any suitable shape, such as the above-described ball-shape.

In some implementations, the announcer ball 200 is configured (e.g., sized/and or shaped) such that a user can hold and then throw or otherwise deploy the announcer ball 200 from the user's hand. In some implementations, the announcer ball 200 may be any other suitable configuration such that a user can deploy the announcer ball 200.

FIG. 3 illustrates another implementation of an example announcer ball 300 according to the present disclosure. In some implementations, the announcer ball 300 is generally the same or similar to the announcer ball 200 described herein for FIGS. 2A-2D except that the announcer ball 300 does not comprise a multi-face frame like the announcer ball 200 does.

In some implementations, the announcer ball 300 is otherwise the same or similar to the announcer ball 200 of FIGS. 2A-2D described herein.

In some implementations, the announcer ball 100, 200, 300 is configured and used to help reduce the chance of injury to dwelling occupants and police when the police use a no-knock warrant to enter a dwelling or otherwise enter a dwelling.

In some implementations, the announcer ball 100, 200, 300 is configured to and used to help quickly identify police once they have made entry into a dwelling pursuant to a no-knock warrant or otherwise.

In some implementations, the announcer ball 100, 200, 300 is configured to emit blue light as a visual indicator to announce the presence of police once they have made entry into a dwelling pursuant to a no-knock warrant or otherwise. In this way, in some implementations, use of the announcer ball 100, 200, 300 is advantageous over only a verbal or other sound indicator since sound indicators may not be heard over the commotion of a no-knock warrant entry or other noise in the environment.

In some implementations, the announcer ball 100, 200, 300 is configured to emit blue light when the announcer ball 100, 200, 300 is tossed, rolled, thrown, or otherwise deployed into a dwelling during entry by police pursuant to a no-knock warrant.

In some implementations, the announcer ball 100, 200, 300 may be configured to provide any other suitable indicator to announce the presence of police once they have made entry into a dwelling pursuant to a no-knock warrant or otherwise.

In some implementations, the announcer ball 100, 200, 300 may be configured to emit any other suitable colored light when the announcer ball 100, 200, 300 is used.

In some implementations, the announcer ball 100, 200, 300 may be used for other forced and/or unannounced entry by law enforcement, such as to serve other applicable warrants (e.g., arrest, fugitive, etc.), particularly during non-daylight times.

In some implementations, the announcer ball 100, 200, 300 may be used for forced and/or unannounced entry by other entities, such as emergency medical personnel, utility personnel (e.g., responding to a gas leak or other applicable utility emergency), or other applicable service providers (e.g., for maintenance services, deliveries, etc.).

In some implementations, the announcer ball 100, 200, 300 comprises any suitable dimensions. For example, in some implementations, the announcer ball 100, 200, 300 may comprise any suitable dimensions to function and be used as described herein. In some implementations, the announcer ball 100, 200, 300 may be similar to the size of a baseball or softball.

FIGS. 2H-2K illustrate other example dimensions of the announcer ball 200 that may also apply to the announcer ball 100, 300, wherein the dimensions shown are in millimeters and the dimensions shown in parentheses are in inches.

In some implementations, the announcer ball 100, 200, 300 is composed of any suitable materials. For example, in some implementations, the announcer ball 100, 200, 300 may be composed of any suitable materials to function and be used as described herein. In some implementations, the announcer ball 100, 200, 300 may be composed of a durable and resilient material such that the announcer ball 100, 200, 300 can withstand being tossed, rolled, thrown, or otherwise deployed into a dwelling or other suitable location.

In some implementations, the announcer ball 100, 200, 300 may be composed, for example, of a plastic material, such as ABS PC (acrylonitrile butadiene styrene polycarbonate) or PMMA (polymethyl methacrylate or acrylic glass) that forms the structure having an enclosure.

In some implementations, the announcer ball 100, 200, 300 can have any suitable appearance. For example, in some implementations, the announcer ball 100, 200, 300 may comprise any suitable appearance to function and be used as described herein, such as the appearance shown in the figures.

In some implementations, an example method of using the announcer ball 100, 200, 300, with respect to the above-described figures, comprises throwing or otherwise deploying the announcer ball 100, 200, 300 into a dwelling or other suitable location. In some implementations, the announcer ball 100, 200, 300 emits a lighted (e.g., blue light) visual indicator that serves to announce the presence of police during the execution of a no-knock warrant or otherwise.

In some implementations, the announcer ball 100, 200, 300 may be deployed into a dwelling before or during the police making entry into the dwelling pursuant to a no-knock warrant or otherwise. For example, in some implementations, the announcer ball 100, 200, 300 may be deployed once police have opened an entryway, such as a door or window, just before entering a home pursuant to a no-knock warrant or otherwise.

In some implementations, the announcer ball 100, 200, 300 may be deployed at any other suitable time during the execution of a no-knock warrant by police or otherwise.

In some implementations, the light sources 120, 223 may be turned on manually by a user before or after deploying the announcer ball 100, 200, 300. For example, in some implementations, the light sources 223 may be turned on by using the power switch 240. As another example, the light sources may be turned on using a remote control after deploying the announcer ball 100, 200, 300.

In some implementations, the light sources 120, 223 may be turned on automatically when the announcer ball 100, 200, 300 is deployed. In some implementations, the light sources 120, 223 may be turned on in any other suitable way.

In some implementations, the announcer ball 100, 200, 300 is deployed such that announcer ball 100, 200, 300 visually alerts home occupants of the presence of police and thereby prevents accidental injury or death to police and the occupants during execution of a no-knock warrant.

Although implementations of the announcer ball 100, 200, 300 may be described herein with respect to police or law enforcement executing a no-knock warrant, it will be understood by one skilled in the art in light of the present disclosure that implementations of the announcer ball 100, 200, 300 may be configured and/or used for executing any other suitable warrants and/or by any other suitable entities for any other suitable purposes involving forced and/or unannounced entry to premises, such as described above.

The figures, including photographs and drawings, comprised herewith may represent one or more implementations of the announcer ball 100.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An apparatus for indicating entry and presence of a person into a dwelling to occupants in the dwelling, the apparatus comprising:
outer walls forming an enclosure; and
one or more light sources configured to radiate light from the outer walls.

2. The apparatus of claim 1 wherein the one or more light sources are configured to radiate blue light.

3. The apparatus of claim 1 wherein the outer walls form a ball-like structure.

4. The apparatus of claim 1 wherein the outer surface of the outer wall comprises a plurality of faces wherein each face is a polygon.

5. The apparatus of claim 4, wherein the outer surface of the outer wall forms a truncated icosahedron.

6. The apparatus of claim 1 wherein the outer walls form a round structure.

7. The apparatus of claim 1 wherein the one or more light sources are housed in the enclosure.

8. A method of using the apparatus of claim 1, the method comprising:
deploying the apparatus into a dwelling;
turning on the one or more light sources; and
entering the dwelling.

9. The method of claim 8 further comprising
obtaining a no-knock warrant for the dwelling; and
executing the no-knock warrant after entering the dwelling.

10. A method of using the apparatus of claim 1, the method comprising:
obtaining a no-knock warrant for a dwelling;
deploying the apparatus into a dwelling;
turning on the one or more light sources;
entering the dwelling; and
executing the no-knock warrant.
